(19) United States
(12) Patent Application Publication
(10) Pub. No.: US 2006/0248513 A1
(43) Pub. Date: Nov. 2, 2006

(54) z/OS rapid automated deployment method

(76) Inventors: Gavin Andrew Eric Foster, Birkdale (AU); Randy Scott Johnson, O'Fallon, MO (US); James Michael Kenley, Erie, CO (US); Tedrick Neal Northway, Wood River, IL (US); Neil Wallace O'Connor, Hornsby Heights (AU); Brian T. Wong, Raleigh, NC (US); Clea Anne Zolotow, Golden, CO (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/116,077

(22) Filed: Apr. 27, 2005

(51) Int. Cl. G06F 9/44

(52) U.S. Cl. 717/127

(57) ABSTRACT

The invention is a system for installing a new operating system on a logical partition that has no existing software or data. The system comprises a baseline code and a process for customizing and configuring the baseline code for use in an on-demand environment. The process for customizing and configuring the baseline code comprises establishing a plurality of datasets that allow users to access the operating system after installation. The critical datasets that produce an operable system include virtual telecommunications parameters, job entry system parameters, operating system parameters, and security parameters.

### FIELD OF THE INVENTION

The invention is related to processes and apparatus for controlling the installation of software programs, and includes means or steps for setting up and preparing an operating system on a computer system.

### BACKGROUND OF THE INVENTION

For many years, information technology (IT) organizations (the “providers”) have offered IT management services and computing resources to other business entities (the “customers”). In a “traditional” service model, the customers share a provider's management services, but each customer purchases or leases specific resources for the customer's exclusive benefit. The customer may purchase or lease the resources directly from the provider or from a third party. Regardless of their origins, though, such a purchase or lease may require extensive, time-consuming negotiations based upon the customer's anticipated requirements. If the customer's requirements are less than anticipated, then the customer effectively has wasted resources. If, however, the customer's requirements are greater than anticipated, then the customer may have to enter into additional time-consuming negotiations for the necessary resources. Customers of “on-demand” services, on the other hand, share the provider's management services and computing resources (to the system and subsystem level), including persistent memory (“storage”), volatile memory (“memory”), and processors.

The on-demand service model addresses many of the problems of the traditional model, including wasted resources and time-consuming negotiations, but it also presents some unique problems of its own. Specifically, an on-demand environment should provide each customer with a clean operating environment that is free from residual data left behind by other customers. The on-demand environment also should present a consistent (or “standardized”) software configuration and layout for all customers to reduce the cost of initial installation and post-installation support. To further control costs, the tasks required to meet these requirements should be automated as much as possible, thereby minimizing the time required to prepare a system for new customers. Preparing the operating system is perhaps the single most labor intensive and time consuming task associated with allocating resources for a new customer. Thus, any process or apparatus that can reduce the labor or time required to install an operating system and prepare it for a customer's use will benefit the on-demand service provider.

To date, the preferred method of installing an operating system in an on-demand environment has been to build it from scratch and install it onto a “bare” system. Consequently, this method is referred to commonly as the “bare iron” method. This nomenclature reflects the traditional principle that, before the operating system is installed, a computer system has no other software installed and, thus, is nothing more than a collection of non-operational hardware components. Of course, in the on-demand environment this traditional principle carries over to sub-systems allocated to particular customers (i.e. an LPAR), rather than the entire system, but is nonetheless still an apt characterization of the method. An overview of the tasks required to apply the bare iron method to install an operating system on an LPAR is provided in FIG. 1. More specifically, FIG. 1 refers to the installation of the z/OS operating system developed and marketed by International Business Machines Corporation (IBM). The bare iron method often is used because it produces a “cleaner” environment than other methods, but as FIG. 1 indicates the method is time consuming and labor intensive. On average, the bare iron method takes about five weeks to complete.

“Cloning” is an alternative to bare iron installation that is used sometimes to reduce the time and labor required to produce an operational environment. FIG. 2 illustrates the tasks generally required to clone a z/OS system and prepare it for operation. As FIG. 2 indicates, a new system is not built from scratch when cloning. Rather, a model system is copied to the new system and then the new system is configured as needed. On average, the cloning method can reduce the time required to completely install a new system by two weeks when compared to the bare iron method. While this might be thought of as an acceptable practice in some environments, cloning does carry inherent faults and problems, such as the propagation of old user IDs, passwords, and catalog entries. Other software applications and system data from the cloned system, which are not desirable in the new system, also frequently find their way to the new system because of this “cloning” approach. Moreover, the average time and labor savings described above are sometimes offset completely by the time and labor required to address these problems.

Thus, a need remains for an operating system installation process that reduces the time requirements of bare iron installations while eliminating the undesirable side-effects of cloning.

### SUMMARY OF THE INVENTION

The invention is a system for installing a new operating system on a logical partition that has no software or data previously installed. The system comprises a baseline code and a process for customizing and configuring the baseline code for use in an on-demand environment. The process for customizing and configuring the baseline code comprises establishing a plurality of datasets that allow users to access the operating system after installation. The critical datasets that produce an operable system include virtual telecommunications parameters, job entry system parameters, operating system parameters, and security parameters.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is a flowchart of the prior art “bare iron” deployment method;

FIG. 2 is a flowchart of the prior art “cloning” method;

FIG. 3 is a schematic of an exemplary memory having components of the present invention loaded therein; and

FIG. 4 is a flowchart of the Rapid Automated Deployment (RAD) method of the present invention.

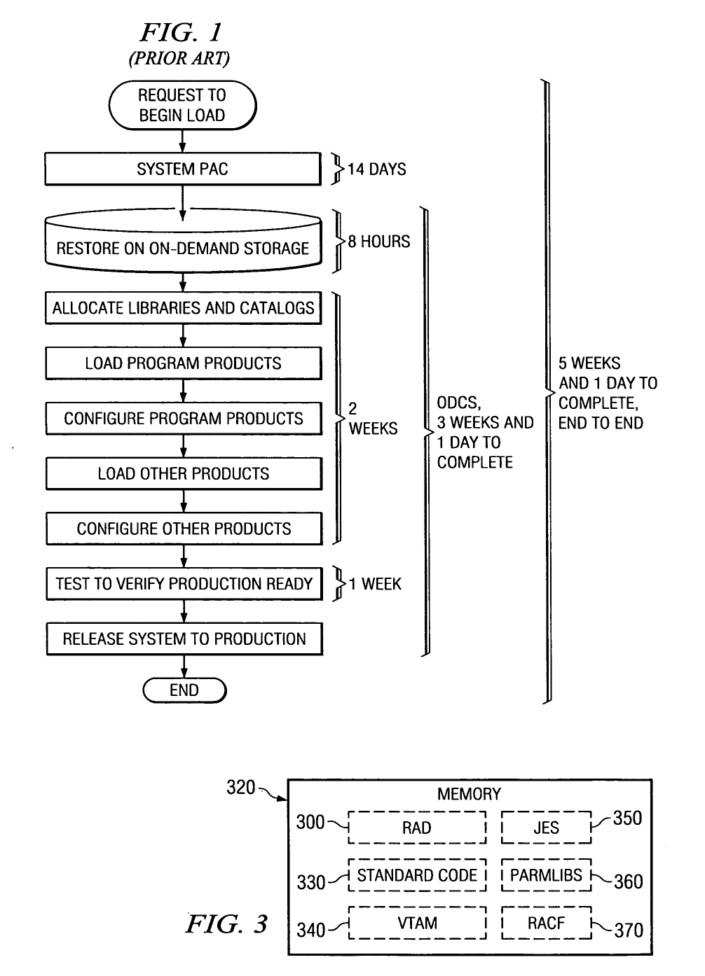

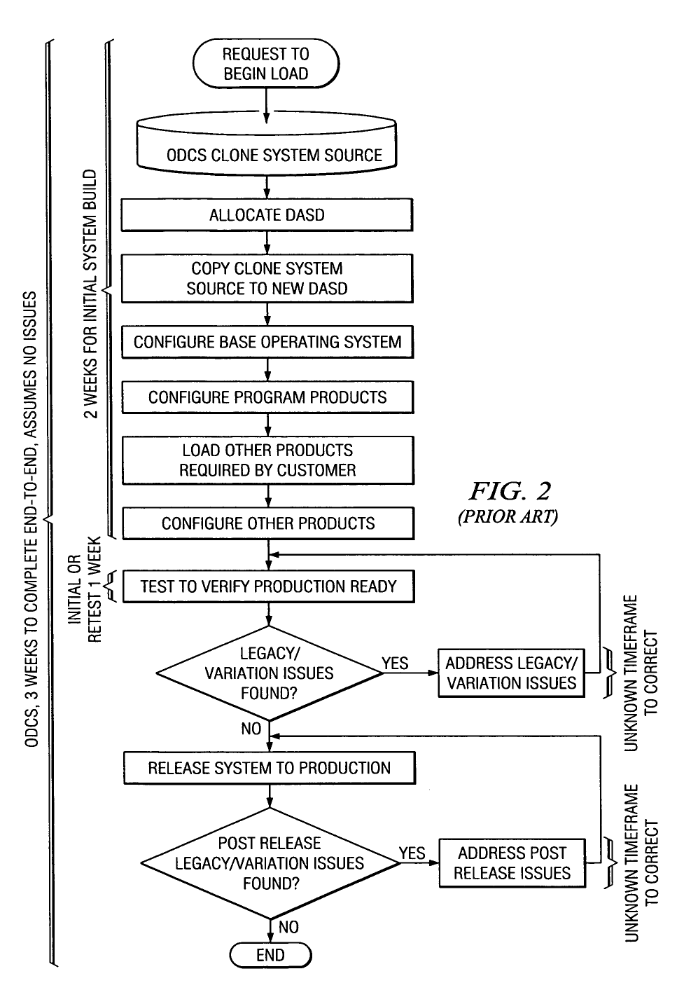

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Rapid Automated Deployment” (RAD) program.

Additionally, the RAD program is described below with reference to an exemplary computing environment. The exemplary computing environment is a shared mainframe environment suited for delivering services “on-demand,” as described above, and includes at least one logical partition (LPAR).

The RAD program operates on a baseline operating system package. The baseline operating system package, referred to herein as the “standard code,” is designed to lay a foundation for a wide variety of environments and generally conforms to a given set of standards, which are based upon industry-accepted practices, an organization's internal practices, or some combination thereof. Generally, though, the standard code is inoperable without additional components and configuration. The RAD program automates the process of adding components and configuring the system to provide an operational environment. In the preferred embodiment described below, the RAD program deploys the standard code on an LPAR and enables an on-demand operational environment. The RAD program is intended to produce a standard system platform that provides common functionality and processes within each system, and reduce the labor, time to build, and the level of skill required to deploy such a standard system platform.

RAD 300 typically is stored in a memory, represented schematically as memory 320 in FIG. 3. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 3 is included merely as a descriptive expedient and does not necessarily reflect any particular physical embodiment of memory 320. As depicted in FIG. 3, though, memory 320 may include additional data and programs. Of particular importance to RAD 300, memory 320 may include standard code 330, upon which RAD 300 operates. FIG. 3 also depicts essential datasets that RAD 300 uses or creates during execution, including virtual telecommunications (VTAM) parameters 340, job entry system (JES) parameters 350, operating system parameters (PARMLIBS) 360, and security (RACF) parameters 370. These items are described in detail below.

In one embodiment, the standard code is stored in a central repository and is transmitted over a network directly to a target LPAR. An administrator then must add components and execute RAD 300 to produce an operational environment for a customer. Components that are typically added to the system include storage devices and automation tools.

The storage devices typically are direct access storage devices (DASD). These storage devices are provided for a variety of functions familiar to those skilled in the art, such as for spool volumes, paging packs, system catalogs, and resource access control facility (RACF) packs. Spool volumes are used to store job input and output until an operator reads it, prints it, or otherwise disposes of it. Paging packs are temporary storage for system operations, which provide space for the operating system to place infrequently used components of a program's working memory. System catalogs include indices that allows an operating system to locate data quickly when a process or program requests the data. RACF packs store much of an operating system's security data, including user IDs and passwords.

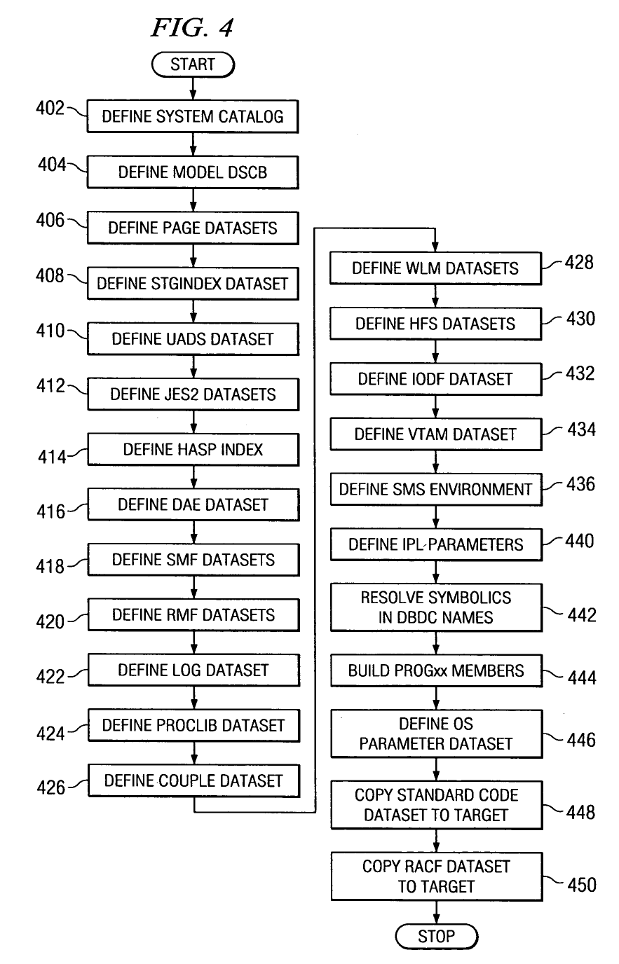

RAD 300 configures a variety of components in the operating system, including components of standard code 330 and the additional components described above. RAD 300 is capable of extensive customization and configuration activities, and the following description is not exhaustive. Rather, FIG. 4 and the following description provide details on the most common and most essential activities. The essential activities include defining a plurality of datasets that allow users to access the operating system after installation. The critical datasets that produce an operable system include virtual telecommunications parameters 340 (defined in step 434), job entry system parameters 350 (defined in step 412), operating system parameters (PARMLIBS) 360 (defined in step 446), and security parameters 370 (copied in step 450). Unless otherwise indicated in context, the order of the activities is not essential to the operation of RAD 300. The virtual telecommunications parameters control a protocol that allows operators to communicate with the operating system and devices associated with the operating system, thus enabling remote users to log in to the system after it is installed. The job entry system parameters control a job entry facility that allows an operator to submit jobs to the operating system. The operating system parameters may vary according to the environment and customer needs, and those skilled in the art should be able to define the operating system parameters to satisfy such variations without additional discussion here. Lastly, the security parameters implement consistent security rules and policies, and include the RACF datasets described above.

Other common activities illustrated in FIG. 4 include defining the system catalog (402), a model data set control block (DSCB) (404), paging datasets (406), a virtual input/output journaling dataset (STGINDEX) (408), a user attribute dataset (UADS) (410), a Houston Automatic Spooling Priority (HASP) index (414), an error recording (LOG) dataset (422), procedures library (Proclib) dataset (424), a Couple dataset (426), a hierarchical file system (HFS) dataset (430), an I/O definition file (IODF) dataset (432), a System-Managed Storage (SMS) environment (436), and the initial program load (IPL) parameters (440). In the preferred embodiment, RAD 300 installs a z/OS system and, consequently, defines datasets specific to z/OS, including a Dump Analysis and Elimination (DAE) dataset (416), System Management Facilities (SMF) datasets (418), Resource Measurement Facility (RMF) datasets (420), and Work-Load Management (WLM) datasets (428). DAE is used to eliminate duplicate or unnecessary memory dumps, while SMF collects and records system and job-related information. Information that SMF collects can be used for a variety of tasks, such as billing customers, generating reliability reports, analyzing the system configuration, scheduling jobs, and maintaining system security. RMF components provide resources and tools for gathering, reporting, and accessing data across the system. Typically, RAD 300 also resolves symbolics in database data communications (DBDC) names (442), builds PROGxx members (444), and copies a standard code dataset to the target LPAR (448).

As described above, the RAD system provides a standard approach for operating system deployments that results in reduced labor costs by reducing the time required to deploy a new operating system and by reducing the skill and knowledge level required to deploy a new operating system. The RAD system also minimizes propagation and variance issues associated with prior art cloning techniques.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer-implemented process for installing and configuring a baseline operating system for use in a shared computing environment, the process comprising:
loading the baseline operating system on a storage device;
defining telecommunications parameters that allow an operator to communicate with the baseline operating system;
loading the telecommunications parameters on the storage device;
defining job entry system parameters that allow the operator to schedule jobs to be executed by the baseline operating system;
loading the job entry system parameters on the storage device;
defining operating system parameters that enable the operating system to execute;
loading the operating system parameters on the storage device;
defining security parameters that restrict access to the operating system to authorized operators; and
loading the security parameters on the storage device.

2. The computer-implemented process of claim 1 wherein the storage device is a logical partition in a mainframe computer.

3. The computer-implemented process of claim 1 further comprising:
defining a system catalog;
loading the system catalog on the storage device;
defining a model dataset control block;
loading the model dataset control block on the storage device;
defining a page dataset;
loading the page dataset on the storage device;
defining a virtual input/output journaling dataset;
loading the virtual input/output journaling dataset on the storage device;
defining a user attribute dataset;
loading the user attribute dataset on the storage device;
defining an automatic spooling priority index;
loading the automatic spooling priority index on the storage device;
defining a dump analysis and elimination dataset;
loading the dump analysis and elimination dataset on the storage device;
defining a system management facilities dataset;
loading the system management facilities dataset on the storage device;
defining a resource measurement facility dataset;
loading the resource measurement facility dataset on the storage device;
defining a procedures library dataset;
loading the procedures library dataset on the storage device;
defining a workload management dataset;
loading the workload management dataset on the storage device;
defining a hierarchical file system dataset;
loading the hierarchical file system dataset on the storage device;
defining an input/output definition file dataset; and
loading the input/output definition file dataset on the storage device.

4. The computer-implemented process of claim 3 further comprising:
resolving symbolics in database data communication names; and
building PROGxx members.

5. The computer-implemented process of claim 3 wherein the storage device is a logical partition in a mainframe computer.

6. The computer-implemented process of claim 4 wherein the storage device is a logical partition in a mainframe computer.

7. A rapid automated deployment system for installing a new operating system, the rapid automated deployment system comprising:
a storage device having no software or data installed thereon;
a baseline operating system;
a processor;
a memory; and
a computer program loaded in the memory that causes the processor to
load the baseline operating system on the storage device,
define telecommunications parameters that allow an operator to communicate with the
baseline operating system,
load the telecommunications parameters on the storage device,
define job entry system parameters that allow the operator to schedule jobs to be executed by the baseline operating system,
load the job entry system parameters on the storage device,
define operating system parameters that enable the operating system to execute,
load the operating system parameters on the storage device,
define security parameters that restrict access to the operating system to authorized operators, and
load the security parameters on the storage device.

8. The rapid automated deployment system of claim 7 wherein the baseline operating system is a Z/OS operating system.

9. The rapid automated deployment system of claim 7 wherein the storage device is a logical partition in a mainframe computer.

10. The rapid automated deployment system of claim 8 wherein the computer program further causes the processor to:
define a system catalog;
load the system catalog on the storage device;
define a model dataset control block;
load the model dataset control block on the storage device;
define a page dataset;
load the page dataset on the storage device;
define a virtual input/output journaling dataset;
load the virtual input/output journaling dataset on the storage device;
define a user attribute dataset;
load the user attribute dataset on the storage device;
define an automatic spooling priority index;
load the automatic spooling priority index on the storage device;
define a dump analysis and elimination dataset;
load the dump analysis and elimination dataset on the storage device;
define a system management facilities dataset;
load the system management facilities dataset on the storage device;
define a resource measurement facility dataset;
load the resource measurement facility dataset on the storage device;
define a procedures library dataset;
load the procedures library dataset on the storage device;
define a workload management dataset;
load the workload management dataset on the storage device;
define a hierarchical file system dataset;
load the hierarchical file system dataset on the storage device;
define an input/output definition file dataset; and
load the input/output definition file dataset on the storage device.

11. The rapid automated deployment system of claim 10 wherein the computer program further causes the processor to:
resolve symbolics in database data communication names; and
build PROGxx members.

12. The rapid automated deployment system of claim 10 wherein the storage device is a logical partition in a mainframe computer.

13. The rapid automated deployment system of claim 1 1 wherein the storage device is a logical partition in a mainframe computer.

14. A computer-readable medium encoded with instructions for executing a method for installing and configuring a baseline operating system for use in a shared computing environment, the method comprising:
loading the baseline operating system on a storage device;
defining telecommunications parameters that allow an operator to communicate with the baseline operating system;
loading the telecommunications parameters on the storage device;
defining job entry system parameters that allow the operator to schedule jobs to be executed by the baseline operating system;
loading the job entry system parameters on the storage device;
defining operating system parameters that enable the operating system to execute;
loading the operating system parameters on the storage device;
defining security parameters that restrict access to the operating system to authorized operators; and
loading the security parameters on the storage device.

15. The computer-readable medium of claim 14 wherein the baseline operating system is a Z/OS operating system.

16. The computer-readable medium of claim 14 wherein the storage device is a logical partition in a mainframe computer.

17. The computer-readable medium of claim 15 wherein the method further comprises:
defining a system catalog;
loading the system catalog on the storage device;
defining a model dataset control block;
loading the model dataset control block on the storage device;
defining a page dataset;
loading the page dataset on the storage device;
defining a virtual input/output journaling dataset;
loading the virtual input/output journaling dataset on the storage device;
defining a user attribute dataset;
loading the user attribute dataset on the storage device;
defining an automatic spooling priority index;
loading the automatic spooling priority index on the storage device;
defining a dump analysis and elimination dataset;
loading the dump analysis and elimination dataset on the storage device;
defining a system management facilities dataset;
loading the system management facilities dataset on the storage device;
defining a resource measurement facility dataset;
loading the resource measurement facility dataset on the storage device;
defining a procedures library dataset;
loading the procedures library dataset on the storage device;
defining a workload management dataset;
loading the workload management dataset on the storage device;
defining a hierarchical file system dataset;
loading the hierarchical file system dataset on the storage device;
defining an input/output definition file dataset; and
loading the input/output definition file dataset on the storage device.

18. The computer-readable medium of claim 17 wherein the method further comprises:
resolving symbolics in database data communication names; and
building PROGxx members.

19. The computer-readable medium of claim 17 wherein the storage device is a logical partition in a mainframe computer.

20. The computer-readable medium of claim 18 wherein the storage device is a logical partition in a mainframe computer.
